(19) United States
(12) Patent Application Publication
(10) Pub. No.: US 2007/0071006 A1
(43) Pub. Date: Mar. 29, 2007

(54) Delivery of communications services in developing regions

(76) Inventors: Peter Bosch, New Providence, NJ (US); Alan Michael Lyons, Malahide (IE); Louis Thomas Manzione, West Hartford, CT (US); Francis Joseph Mullany, Castleknock (IE); Kazutaka Murakami, Freehold, NJ (US); Louis Gwyn Samuel, Swindon (GB); Michael J. Schabel, Clark, NJ (US)

Correspondence Address: Lucent Technologies Inc.;Docket Administrator - Room 3J-219, 101 Crawfords Corner Road, Holmdel, NJ, 07733-3030, US

(21) Appl. No.: 11/235,515

(22) Filed: Sep. 26, 2005

(51) Int. Cl. H04L 12/56

(52) U.S. Cl. 370/392; 370/401; 379/265.02; 379/127.01; 370/356

(57) ABSTRACT

A technique for delivering communications services to a large number of users employing relatively inexpensive, widely available handsets. More particularly, the technique utilizes a network apparatus that supports individual access to a community of users and supports access to a wireless communications system (e.g., any well-known Code Division Multiple Access (CDMA) wireless network). That is, the communications hub functions similar to a communications switch with a number users employing inexpensive handsets (e.g., well-known 900 MHz cordless telephones) on one side and the functionality of a mobile terminal, and CDMA interconnection, on the other side. Therefore, the users (i.e., subscribers) employ relatively inexpensive, widely available handsets, in conjunction with the network apparatus, to access a wireless communications network and the associated communications services offered from the wireless service provider.

### RELATED APPLICATION

The present application is related to U.S. patent application Ser. No. 10/689,363, filed on Oct. 20, 2003, in the name of inventors M. Buddhikot et al. and entitled “Mobility Access Gateway”, which is hereby incorporated by reference herein.

### FIELD OF THE INVENTION

The present invention relates generally to communications systems and, more specifically, to delivering wireless communications services in developing regions with minimal infrastructure investment and utilizing low cost, widely available handsets.

### BACKGROUND OF INVENTION

The ability to communicate and access information is a basic element of current culture. Today, individuals have the ability to subscribe to any number of commercially available personal communications services offered by communications service providers, that provide these individuals with access to a wide array of voice, data and video services. Using these communications services, individual subscribers can place worldwide phone calls, access and download information from the well-known Internet, and take and transmit pictures to others, to name just a few possibilities. Even more impressive is that in today's communications world all of these services are accessible through the subscriber's wireless terminal, for example, a wireless telephone or personal digital assistant. Obviously, access to such communications capabilities has great advantages from many vantage points such as social and economic. In industrial and developed regions of the world (for example, the United States of America, Europe and parts of Asia) the economic investment in the communications infrastructure necessary for the delivery of these communications services continues to be made, either by private industry or governments, thereby making access to such services widely available. Further, the economic status of the user (i.e., subscriber) base in these developed regions is such that these subscribers are generally able to afford the communications devices (for example, cellular phone) and services fees associated with the delivery of such services.

In contrast, in other developing regions of the world, the investment in the requisite infrastructure has not been made and, if planned, will take many years to fully complete. Also, the geographic topologies or remoteness of such regions make it virtually impossible, from an economic standpoint, to justify the installation of expensive wireline or optical fiber networks to deliver the aforementioned communications services. Furthermore, the socioeconomic realities in these developing regions of the world make it infeasible for individuals to afford the communications devices necessary to gain access to even the most fundamental communications services, for example, placing a wireless call.

Given the significant opportunity presented in these regions of the world, in terms of personal communications services, an increased focus has been placed on studying and implementing communications networks to provide, for example, telephony and Internet connectivity (see, e.g., M. Pipattanasomporn et al., “Information and Communication Technology Infrastructure and Its Distributed Generation Solutions in Remote Areas”, in Proc. 2002 the International Conference on Electrical and Computer Engineering (ICECE), Dhaka, Bangladesh, December 2002, which is hereby incorporated by reference herein). In M. Pipattanasomporn et al., supra., existing and new architectures are discussed which utilize wireless access systems for the delivery of telecommunications services and Internet access to rural households.

In Pipattanasomporn et al., supra., one such architecture is a so-called TDMA-WLL system for providing telephone services to remote villages located in Thailand. The TDMA-WLL is considered an alternative to Plain Old Telephone Service (POTS) using a combination of a wireless access and wireline system. In particular, this system employs two subsystems: (1) a 2.4-GHz band Time Division Multiple Access (TDMA) point-to-multipoint subsystem; and (2) a 1.9 GHz band PHS-WLL subsystem. While this system offers certain advantages in the delivery of telephone services to remote locations, the apparent use of an unlicensed 2.4-GHZ TDMA band will introduce certain limitations. These include the potential for interference arising from other systems using the same band, the potentially high cost of the specialized equipment for the 2.4 GHz TDMA point-to-multipoint system, and the inability to use off-the-shelf wireless terminals that are generally designed and manufactured for use with licensed TDMA bands.

Of course, the infrastructure requirements of delivering communications services to remote or developing regions is only one element of the overall problem. As mentioned above, individual access to a mobile communications network is achieved through individual mobile handsets or terminals. As will be appreciated, the cost of such mobile handsets is high as compared to the cost of conventional corded or cordless telephones. So, in terms of a fully mobile communications system deployment in remote or developing regions, it can be shown that the total mobile handset costs outweigh the cost of the wireless infrastructure. That is, the infrastructure costs per subscriber are low since such costs are shared between a large number of subscribers, but irrespective of the size of the subscriber base, one mobile handset is required per subscriber. Further, unlike developed regions, the expected monthly revenue per subscriber is low in developing regions, resulting in a longer period before the handset investment is recouped.

As a result, the cost of the mobile handset is a critical factor in determining the overall viability of base station infrastructure in developing regions. As such, wireless handset manufacturers continue to investigate designs that will reduce the overall wireless handset cost (and resulting price to the subscriber). Interestingly, the GSM™ Association, in response to demand in emerging markets, announced an initiative directed at defining a new “ultra-low cost” handset market segment (see, for example, http://www.gsmworld.com/emh/media.html) with the ultimate goal of working towards achieving Global System for Mobile (GSM) wireless handsets which retail for less than thirty U.S. dollars ($30).

However, despite the expanding availability of ultra-low cost wireless handsets, the overall affordability and the widespread distribution of such handsets in developing regions continues to be a challenge. Therefore, it would be desirable to have a way to provide access to communications services to large numbers of users that employs subscriber hardware (e.g., a handset) meeting the economic realities of the users in developing regions, for example.

### SUMMARY OF THE INVENTION

Accordingly, we have realized a technique for delivering communications access to a large number of users that employs relatively inexpensive, widely available handsets, which allow such users to access communications services.

More particularly, the various aspects of the present invention are directed to utilizing a network apparatus (alternatively referred to hereinafter as a “community hub” or “hub”) that supports individual access to a community of users and supports shared access to a wireless communications system (e.g., a well-known Code Division Multiple Access (CDMA) wireless network). That is, the communications hub of the present invention, functions similar to a communications switch with a plurality of users employing inexpensive handsets (e.g., analog cordless telephones, digital cordless telephones such as a well-known 900 MHz cordless telephones or other digital cordless standards) on one “access” side and the functionality of a mobile terminal, and CDMA interconnection, on the other “cellular” (or “wireless”) side. Therefore, in accordance with the principles of the invention, the users (i.e., subscribers) employ relatively inexpensive, widely available handsets, in conjunction with the community hub to access a wireless communications network and the associated communications services offered from the wireless service provider, for example.

In accordance with the principles of the invention, the community hub utilizes, in cooperation with each other, the aforementioned two modes of operation (i.e., access and cellular), to deliver three primary functions: (1) Protocol manager—manages the communications between the access side (e.g., 900 MHz digital cordless standard) and wireless backhaul side (e.g., CDMA) of the hub; (2) Switching function—increases wireless channel utilization; and (3) Distance repeater—extendable range. The two modes of operation detailed herein are not intended as two mutually exclusive methods of operation and, as such, the two modes of operation shall be construed generally, and should not be construed as requiring mutually exclusive operation in any of the embodiments of the invention. Advantageously, in accordance with the aspects of the invention, the community hub serves as the communication link between the individual users and the communications infrastructure (i.e., the wireless communications network) for delivery of communications services to the users. The community hub of the present invention utilizes existing cordless telephones, for example, analog cordless telephones (e.g., using the 900 MHz standard) or digital cordless telephones (e.g., frequency bands of 900 MHz, 2.4 GHz, or 5.8 GHz, or other digital cordless telephony standards) and wireless infrastructure (e.g., CDMA2000-1x, GSM or Universal Mobile Telecommunications System (UMTS)) to deliver communications services to a subscriber base in developing regions where communications services were previously unavailable or too expensive for widespread adoption.

Advantageously, the present Applicants have realized, in accordance with a further aspect of the invention, that the use of a protocol conversion feature (integral with the community hub of the present invention) will enable the exploitation of low-cost, off-the-shelf, high-volume cordless telephony solutions for voice communications with end users. In contrast with some communications architectures which expect VoIP (voice over internet protocol) as their input, embodiment of the present invention enable certain protocol conversions between VoIP signaling and the expected signaling protocols associated with the access side of the community hub thereby providing the community hub with the flexibility of interfacing with any number of low-cost, off-the-shelf, high-volume cordless telephones for the delivery of wireless communications services to a subscriber base in developing regions.

Thus, certain aspects of the invention include the necessary protocol conversion, performed directly by the community hub, from VoIP to these expected protocols. For example, for the data plane, illustrative conversions performed by the community hub include decoding or transcoding the encoded voice packets (e.g. from G.729 CS-ACELP to analog voice or, in the case of ISDN, to G.711 PCM). Similarly, the community of hub of the present invention will provide conversions with respect to control plane signaling, for example, from the typical VoIP signaling protocols such as SIP or H.323 to ISUP (in the case of an ISDN-capable cordless access part) or to some non-standard signaling mechanism (in the case of a cordless access part expecting an analog connection).

In accordance with further embodiments of the invention, an operation is employed for receiving a message having a plurality of fields, where the message has a form compliant with a wireless communications protocol (e.g., CDMA), and a control signal is extracted as a function of a particular one field of the plurality of fields. Such one field contains information conforming with a different communications protocol (i.e., the cordless telephony protocol such as a digital cordless telephone standard) but not with the wireless communications protocol, such that the control signal is used for identifying the particular one subscriber associated with the one handset which is in communication with the community hub. Said another way, in accordance with such embodiments of the invention, information useful by the “access” side of the community hub is embedded in the message generated from the “cellular” side of the community hub. Thus, the message transmitted by the wireless communications network (as received by the community hub) is in a form compliant with the relevant wireless communications protocol but a particular field of such message contains information which conforms with (i.e., will be recognized by and useful with) the other (i.e., different than the wireless communications protocol associated with the wireless network) communications protocol being utilized on the “access” side of the hub (i.e., utilized for identifying and communicating with the handsets of the users communicating with the hub)

In further embodiments of the invention, two or more community hubs are connected together thereby creating a mesh network. That is, in these embodiments of the invention, multiple community hubs are interfaced together and when one hub is blocked, other additional calls may be routed utilizing one of the other interconnected hubs.

Further, the community hub in accordance with the principles of the present invention may provide additional functionality such as billing, outgoing call queuing, incoming call routing and messaging, and the ability to interconnect with other community hubs thereby increasing overall network capacity.

These and other objects, features and advantages of the present invention will become apparent to those of ordinary skill in the art from the following detailed description of illustrative embodiments thereof, which is to be read in connection with the accompanying drawings.

### BRIEF DESCRIPTION OF THE DRAWINGS

FIG. 1 shows an illustrative embodiment of a communications system configured for voice transport, in accordance with the principles of the invention;

FIG. 2 shows an illustrative embodiment of a communications system configured for voice and data transport utilizing Voice over IP (VoIP) infrastructure, in accordance with the principles of the invention;

FIG. 3 shows a functional block diagram of an embodiment of the community hub, as illustratively depicted in FIG. 2, configured in accordance with the principles of the invention;

FIG. 4 shows a functional block diagram of an embodiment of the community hub, as illustratively depicted in FIG. 1, configured in accordance with the principles of the invention;

FIG. 5 shows a flowchart of illustrative operations performed by the community hub, configured in accordance with the principles of the invention, for processing and exchanging a variety of communications; and

FIG. 6 shows a functional block diagram of a further embodiment of the community hub, as illustratively depicted in FIG. 1, configured in accordance with the principles of the invention.

### DETAILED DESCRIPTION OF THE INVENTION

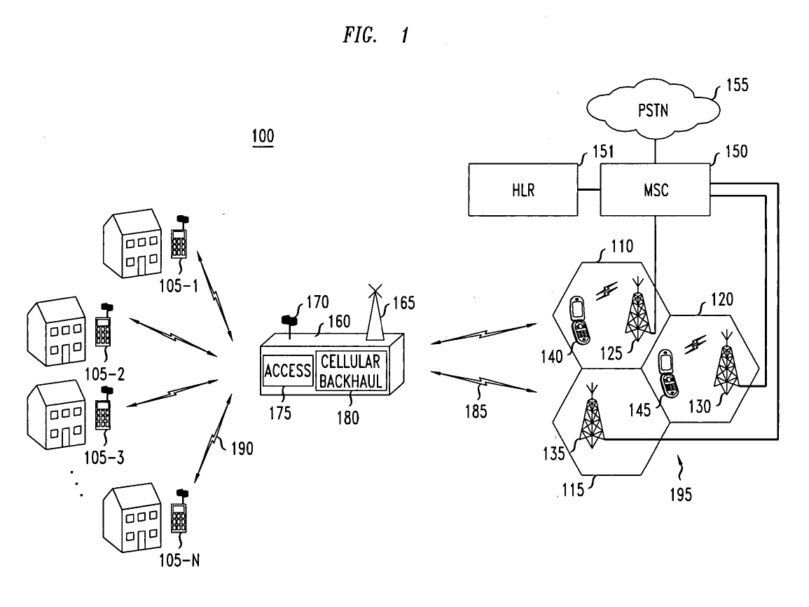

FIG. 1 shows an illustrative embodiment of a communications system configured, for voice transport, in accordance with the principles of the invention. More particularly, FIG. 1 illustrates wireless communications system 195 (illustratively, a CDMA system) that complies, illustratively, with the well-known CDMA 2000 standard. As will be appreciated, the operation of wireless networks is in large part defined by industry standards. These standards specify the air interface specification that allows a mobile terminal (see, for example, FIG. 1, mobile terminal 140 and 145, respectively) to communicate with a base station (see, for example, FIG. 1, base station 125 and 130, respectively). The air interface specification typically includes a set of air interface channels, channel encoding rules and signaling messages to allow the mobile terminal to communicate with the base station. As such, it will be understood, that while the various embodiments of the invention described herein will be illustrated with embodiments employing CDMA, the principles of the invention are equally applicable to other systems employing well-known cellular protocols (and their associated infrastructure, terminal and network elements) such as TDMA, GSM, UMTS and Advanced Mobile Phone Service (AMPS). Further, as the features, implementation and other details of CDMA technology will be well understood by one of ordinary skill in the art such CDMA specific items need not be described in great detail herein.

Turning our attention back to FIG. 1, as is well-known, the geographic areas serviced by CDMA system 195 are divided into a plurality of spatially distinct areas called “cells”, in particular, cells 110, 115 and 120. As will be appreciated, while cells 110, 115 and 120 are depicted, in FIG. 1, as a hexagon in a honeycomb pattern, each cell is actually of an irregular shape that depends on the topography of the terrain surrounding the cell. It will also be appreciated by one skilled in the art that a CDMA system such as CDMA system 195 will have a larger number of cells than as depicted in FIG. 1, which shows a more limited number of cell for purposes of explanation herein. As discussed above, the principles of the invention are directed to the delivery of communications services in developing regions that have either little or no communications infrastructure. Therefore, the topographical traits of these regions will play a role in defining the ultimate shape of the cells. However, as also discussed above, the principles and advantages of the present invention are also directed at using and leveraging existing or newly installed wireless infrastructure for the delivery of communications services to the subscribers in the developing region.

Each cell 110, 115 and 120, respectively, contains one base station 125, 130, and 135, respectively. In turn, base stations 125, 130 and 135 include equipment to communicate, in a well-known manner, with Mobile Switching Center (MSC) 150, which is connected the well-known Public Switch Telephone Network (PSTN) 155. Each base station 110, 115 and 120 also includes antennas and radios (which include a receiver and transmitter) which allow the base stations to communicate, in a conventional manner, with mobile terminals 140 and 145, respectively.

As shown in FIG. 1, communications system 100 includes individual subscribers utilizing cordless handsets 105-1, 105-2, 105-3 through 105-N. Importantly, in accordance with the principles of the invention cordless handsets 105-1, 105-2, 105-3 through 105-N are, for example, conventional 900 MHz digital cordless handsets as available from a variety of well-known consumer handset manufacturers (for example, Panasonic or VTech). It will be further understood that the principles of the invention are applicable to other low cost cordless handsets which include a large variety of analog or digital cordless telephones.

As discussed above, the present Applicants have realized the principles of the invention directed to utilizing a network apparatus that supports individual access to a community of users and supports access to a wireless communications system (e.g., wireless communications system 195). In the above-cited U.S. patent application Ser. No. 10/689,363, a gateway for mobile access is described which is directed at addressing the problems associated with the integration of third generation (3G) wide area networks and 802.11 local area networks to offer seamless connectivity across the two types of networks. In addition, the mobile access gateway described therein may be configured with a wireless backhaul link for functioning in a mobile environment. In such a configuration, subscribers can access the Internet in buses, trains, or hotspots using 802.11 (in the same manner as such subscribers would at home or at work) to connect to a backhaul wireless data channel (such as EV-DO, UMTS, GPRS or other such wireless packet data channel). Despite the considerable advantages and advances provided by this mobile access gateway, the implementation of such gateway is primarily directed at trends indicating that local area wireless networks on the 802.11 standards and 3G wireless networks (e.g., CDMA2000 or UMTS) will co-exist to offer Internet access to end user subscribers. Thus, the problem is one primarily directed to sophisticated subscribers employing state-of-the art networks and high-end handsets providing IP-based services, which (as detailed above) are deployed in industrial and developed regions of the world (for example, the United States of America, Europe and parts of Asia) where the economic investment in the communications infrastructure necessary for the delivery of these communications services continues to be made, either by private industry or governments, thereby making access to such advanced services widely available. No means is provided to bridge handset access technologies that are not IP-based to cellular networks. We have realized a technique utilizing a network apparatus that supports individual access to a community of users and supports shared access to a wireless communications system (e.g., a well-known Code Division Multiple Access (CDMA) wireless network) for delivering communications access to a large number of users that employs relatively inexpensive, widely available handsets. That is, the communications hub of the present invention, functions similar to a communications switch with a number user employing inexpensive handsets (e.g., well-known 900 MHz cordless telephones) on one side and the functionality of a mobile terminal, and CDMA interconnection, on the other side. Therefore, in accordance with the principles of the invention, the users (i.e., subscribers) employ relatively inexpensive, widely available handsets (such as, for example, cordless handsets 105-1 through 105-N as shown in FIG. 1) to access a wireless communications network and the associated communications services offered from the wireless service provider.

Therefore, in accordance with the aforementioned principles of the invention, as shown in FIG. 1, community hub 160 is integral to communications system 100 in the delivery of communications services to the subscriber base. As seen in FIG. 1, community hub includes antenna 170 for communicating with and transmitting to, in a conventional manner over cordless interface 190, a community of subscribers utilizing cordless handsets 105-1 through 105-N. In addition, community hub includes antenna 165 for communicating, in a conventional manner with wireless communications protocols, with CDMA wireless communications system 195 over wireless interface 185. As such, in accordance with the principles of the in invention, community hub 160 in essence has two sets of primary capabilities and modes of operation, namely, an access mode (access portion 175 as shown in FIG. 1), and a cellular mode (cellular portion 180 as shown in FIG. 1). The details of the access and cellular portions of community hub 160 are described in greater detail hereinbelow.

In accordance with the principles of the invention, community hub 160 serves three primary functions: (1) Protocol manager—manages the communications between the access side (e.g., 900 MHz) and wireless backhaul side (e.g., CDMA) of the hub; (2) Switching function—increases wireless channel utilization and (3) Distance repeater—extendable range. Advantageously, in accordance with the aspects of the invention, community hub 160 serves as the communication link between the individual users (and their respective individual handset 105-1 through 105-N) and the communications infrastructure (e.g., wireless network 195) for delivery of communications services to the users. In serving such capacity, no modifications need be made to the cordless handsets utilized by the individual users or the wireless infrastructure.

Advantageously, the present Applicants have realized, in accordance with a further aspect of the invention, that the use of a protocol conversion feature (integral with the community hub of the present invention) will enable the exploitation of low-cost, off-the-shelf, high-volume cordless telephony solutions for voice communications with end users. In contrast with some communications architectures which expect VoIP as their input from the PSTN network, the present invention enables certain protocol conversions between VoIP signaling and the expected signaling protocols associated with the access side of the community hub thereby providing the community hub with the flexibility of interfacing with any number of low-cost, off-the-shelf, high-volume cordless telephones for the delivery of wireless communications services to a subscriber base in developing regions.

Thus, the aspects of the invention include the necessary protocol conversion, performed directly by the community hub, from VoIP to these expected protocols. For example, for the data plane, illustrative conversions performed by the community hub include decoding or transcoding the encoded voice packets (e.g. from G.729 CS-ACELP to analog voice or, in the case of ISDN, to G.711 PCM). Similarly, the community of hub of the present invention will provide conversions with respect to control plane signaling, for example, from the typical VoIP signaling protocols such as SIP or H.323 to ISUP (in the case of an ISDN-capable cordless access part) or to some non-standard signaling mechanism (in the case of a cordless access part expecting an analog connection).

As such, the community hub of the present invention utilizes existing cordless telephones (e.g., 900 MHz or 2.4 GHz) and wireless infrastructure (e.g., CDMA2000-1x, GSM or UMTS) to deliver communications services to a subscriber base in developing regions where communications services were previously unavailable or too expensive for widespread adoption. In accordance with an embodiment of the invention, each subscriber is issued an individual telephone number. Illustratively, the telephone numbers are issued and maintained by the wireless network operator. In accordance with the preferred embodiment of the invention, community hub 160 resides in a location that is preferably in a range of fifty to three hundred meters, consistent with the well-known DECT standard, from the subscribers' handsets (e.g., cordless handsets 105-1 through 105-N). Further, in accordance with the preferred embodiment of the invention, community hub 160 is in a range of ten kilometers (10 km) or less from CDMA system 195. For example, the community hub might be purchased by a local merchant offering communications services whereby the merchant would offer for sale access to the community hub for a fixed fee or pre-paid minutes basis, to name just one of many commercial opportunities involving the community hub.

Illustratively, to place a call, a particular subscriber utilizing cordless handset 105-1 will dial the called party at such called party's wireless telephone number. In accordance with various aspects of the invention, a single one subscriber may gain access to the community hub at any one time. For example, in the current embodiment, once cordless handset 105-1 has gained access to community hub 160 the other handsets (i.e., handsets 105-2 through 105-N) will be blocked for the duration of such access by handset 105-1. To alleviate the deleterious effects of such blocking, in additional embodiments of the present invention certain features are implemented to avoid blocking such as the use of automated call reservation, automatic redialing-on-clear-line or a “call waiting” like feature to queue a second call attempt, to name just a few possibilities. In addition, as detailed below, further embodiments of the invention might include community hub to community hub communications thereby creating a mesh network. That is, in these embodiments of the invention, multiple community hubs are interfaced together and when one hub is blocked, other additional calls may be routed utilizing one of the other interconnected hubs.

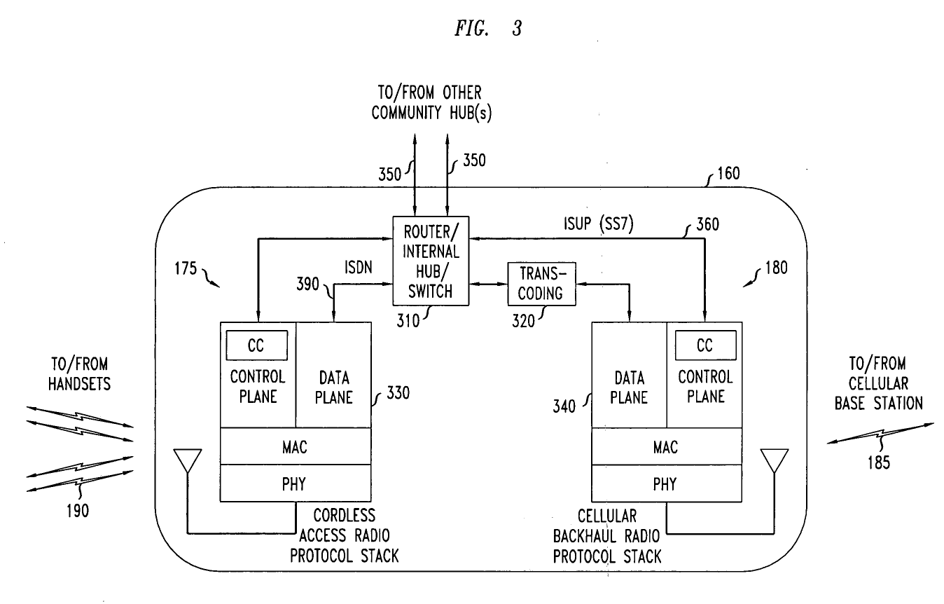

After dialing, the call will be transmitted to community hub 160 across interface 190, where community hub 160 will perform the necessary translations and other operations (such functionality being discussed in greater detail below with reference to at least FIGS. 3-5 herein) to route the call (utilizing the hub's two modes of operation: access 175 and cellular 180 portions) to CDMA wireless communications system 195. Thereafter, CDMA wireless communications system 195 will route the call, in a conventional manner, to the called party, for example, the user associated with wireless terminal 140, or through PSTN 155, illustratively the PSTN, to a called party at their POTS telephone number.

In reverse, a calling party utilizing PSTN 155 may call the subscriber utilizing cordless handset 105-1 by dialing the unique number associated with such subscriber. PSTN 155 and CDMA wireless communications system 195 perform an address translation on such dialed number to identify community hub 160. That is, in accordance with the invention, community hub 160 has a unique identifier associated therewith. As such, after CDMA wireless communications system 195 has determined the identity of the particular hub, the CDMA system will direct the call to community hub 160. Thereafter, community hub 160 will process the call to determine the particular subscriber (i.e., the called party) and transmit the call to that subscriber over interface 190. By way of emphasis, it will be noted in the embodiments of the invention detailed above, access to communications services is provided utilizing conventional cordless handsets, wireless terminals, wireless infrastructure and other associated conventional network elements. That is, the use and introduction of the community hub of the present invention facilitates and provides the necessary operations (such protocol management, switching and distance repeating) to enable access to the communications services. The only modifications required to the wireless infrastructure are some additional functionality in the MSC 150 and the Call Control CC (as detailed below). In one embodiment, it is the MSC that identifies the correct community hub 160 and passes some additional signaling identifying, for the community hub 160, the correct cordless handset 105 to connect to. The Call Control entity (as detailed below) may need to be modified to allow this handset identification from the MSC to be passed through to the Call Control CC in the cordless access radio protocol stack (as detailed below).

Further, in alternative embodiments of the invention, the community hub is dialed directly (that is, the community hub is uniquely and individually accessible by the network) by the calling party and the community hub manages the connection with the called party, illustratively, by requesting from the calling party an additional telephone number to identify the called party. This embodiment has the advantage of allowing the use of conventional cellular technology without modification, that is, the identification of and routing of a call to the cordless handset is left to the community hub.

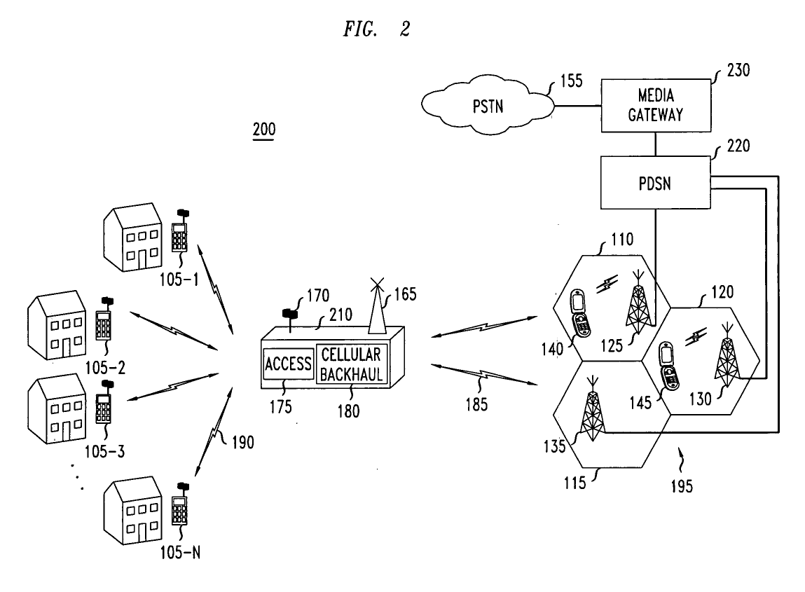

FIG. 2 shows an illustrative embodiment of a communications system configured for voice and data transport utilizing Voice over IP (VoIP) infrastructure, in accordance with the principles of the invention. As seen from FIG. 2, communications system 200 shares many of the same elements as described above with regard to FIG. 1 and another discussion of such common elements need not be repeated here. As will be detailed below, community hub 210 in the FIG. 2 embodiment of the invention, is configured to deliver the same novel features as set forth with the additional capability of delivering such features within a VoIP system architecture. That is, communications system 200 includes the additional elements, as part of CDMA wireless communications system 195, of a well-known packet data serving node (PDSN) 220 which provides access to the Internet/intranets for wireless base stations (e.g., wireless base station 125) and a media gateway 230 which provides access to PSTN 155 for packet-based VoIP services. Essentially, the PDSN serves as a packet switch providing internet protocol (IP), mobile IP access and packet transport capabilities, and media gateway 230 receives packets from PDSN 220 and converting such packets, in a well-known manner, for transmission to PSTN 155. As mentioned previously, the particular communications system configurations described above should be viewed as illustrative examples of the community hub arrangement in accordance with the principles of the invention, and it is to be understood that the invention can be implemented using other types of communications system configurations.

FIG. 3 shows a functional block diagram of an embodiment of community hub 160, as illustratively depicted in FIG. 1. As described above, and as illustrated in the embodiment of FIG. 3, community hub 160 includes two modes of operation, namely, access mode 175 and cellular mode 180. In accordance with this embodiment of the invention, voice calls are exchanged between community hub 160 and the wireless communications network (e.g., wireless communications network 195 as shown in FIG. 1) using well-known and well understood voice transport configurations and methods (e.g., CDMA2000-1X). Thus, the details of cellular radio protocol stack 340 utilized in community hub's cellular mode 180 need not be explained in detail other than to highlight that stack 340 includes a physical (PHY) layer for detecting and decoding transmissions over interface 185, a MAC layer to handle all medium access control functions associated with interface 185, a data plane for further higher-layer functions for the data (in the current embodiment, voice packets), and a control plane for processing higher-layer control signaling. In access mode 175, community hub 160 utilizes cordless access radio protocol stack 330 to manage the communications to and from the subscriber handsets (i.e., handsets 105-1 through 105-N as shown in FIG. 1) across, illustratively, interface 190. As will be well understood, cordless access radio protocol stack 330 includes a physical (PHY) layer for detecting and decoding transmissions over interface 190, a MAC layer to handle all medium access control functions associated with interface 190, a data plane for further higher-layer functions for the data (in the current embodiment, voice), and a control plane for processing higher-layer control signaling. In accordance with this embodiment of the invention, calls are exchanged by community hub 160 with the wireless network over dedicated voice channels. That is, in accordance with the principles of the invention, community hub 160 is able to facilitate a higher utilization of voice channels via the wireless network in that the community hub is able to manage multiple subscribers over one uplink (e.g., one voice channel). This arises because community-hub-based subscribers may be willing to accept higher levels of call blocking than conventional wireless handset users, resulting in higher levels of percentage channel utilization.

In accordance with the embodiment of FIG. 2, switch 310 employs a switched fabric such that, within community hub 160 the transport 390 used to carry communications traffic to/from access portion 175 is the well-known Integrated Services Digital Network (ISDN). In certain situations, where the codec type used for the encoding voice data stream over interface 185 does not correspond with that expected by access portion 175, the voice packets being processed by community hub 160 may need transcoding, therefore, community hub 160 may optionally include transcoder 320 to perform, in a normal manner, the necessary modifications to such voice packets. Transcoding is a well-known procedure for modifying a stream of data, encoded using one method, so that it is transformed according to another method. In order to identify a particular handset (e.g., handset 105-3 as shown in FIG. 1), the well-known Integrated Services Digital Network User Part (ISUP), the call control part of the well-known Signaling System 7 (SS7), is modified to provide ISUP signal to control the address translation function in switch 310 to allow for such identification and routing of the communication thereto, such identification being carried across connection 360.

As mentioned above, the principles of the invention, include embodiments whereby multiple community hubs are interfaced together and when one hub is blocked, other additional calls may be routed utilizing one of the other interconnected hubs. As such, community hub 160 includes optional interconnections 350 to facilitate such interfacing community hub 160 with other community hubs.

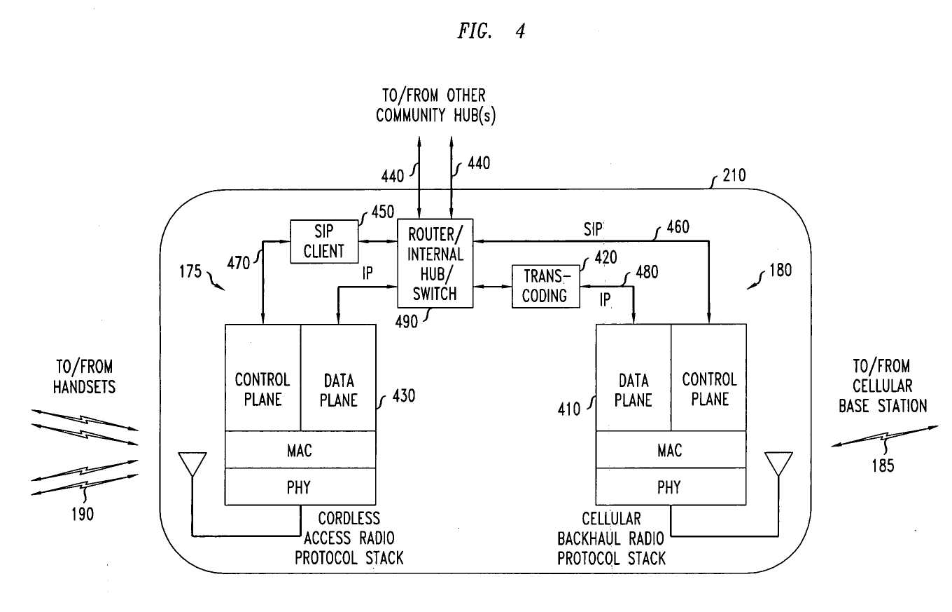

FIG. 4 shows a functional block diagram of an embodiment of the community hub 210, as illustratively depicted in FIG. 2. In accordance with the principles of the invention, community hub 210 again includes two modes of operation, namely, access mode 175 and cellular mode 180. In accordance with this embodiment of the invention, voice calls are exchanged between community hub 210 and the wireless communications network (e.g., wireless communications network 195 as shown in FIG. 2) using well-known VoIP traffic with Session Initiation Protocol (SIP) signaling. Thus, the details of cellular radio protocol stack 410 utilized in community hub's 210 cellular mode 180 need not be explained in detail other than to highlight that stack 410 includes a physical (PHY) layer for detecting and decoding transmissions over interface 185, a MAC layer to handle all medium access control functions associated with interface 185, a data plane for further higher-layer functions for the data (in the current embodiment, voice packets), and a control plane for processing higher-layer control signaling.

In access mode 175, community hub 210 utilizes cordless access radio protocol stack 430 to manage, in accordance with the principles of the invention, the communications to and from the subscriber handsets (e.g., handsets 105-1 through 105-N as shown in FIG. 1) across, illustratively, interface 190. As will be well understood, cordless access radio protocol stack 430 includes a physical (PHY) layer for detecting and decoding transmissions over interface 185, a MAC layer to handle all medium access control functions associated with interface 185, a data plane for further higher-layer functions for the data (in the current embodiment, voice), and a control plane for processing higher-layer control signaling. In accordance with the embodiment of FIG. 4, switch 490 employs a switched fabric such that, within community hub 210 the transport used to carry data and signaling traffic to/from access portion 175 and cellular portion 180 is a combination of IP (see, for example IP signal 480 across the data planes) and SIP protocols. Thus, community hub 210 includes SIP client 450 which will, in addition to other functions, handle the SIP signaling (see, e.g., SIP signals 460 and 470) over interface 185 used to identify the community-hub-based subscriber 105 for calls originating from the PSTN 155 and also initiate the out-going call requests from subscribers 150. In certain situations where the codec type used for the encoding voice data stream over interface 185 does not correspond with that expected by the access portion 175. In certain situations the voice packets being processed by community hub 210 may need transcoding. Therefore, community hub 210 may optionally include transcoder 420 to perform, in a normal manner, the necessary modifications to such voice/data packets. In order to identify a particular handset (e.g., handset 105-3 as shown in FIG. 1), community hub 210 will in SIP client 450, translate the URI (uniform resource identifier) passed via SIP signaling from media gateway 230, into an identifier understood by access part 430.

As mentioned above, the principles of the invention, include embodiments whereby multiple community hubs are interfaced together and when one hub is blocked, other additional calls may be routed utilizing one of the other interconnected hubs. As such, community hub 210 includes optional interconnections 440 to facilitate such interfacing community hub 210 with other community hubs. In accordance with this embodiment of the invention, calls are transmitted by community hub 160 to the wireless network over dedicated data channels or over shared data channels. That is, in accordance with the principles of the invention, community hub 160 is able to facilitate a higher utilization of data channels via the wireless network in that the community hub is able to manage multiple subscribers over one uplink (e.g., one data channel). This arises, as mentioned previously, because community-hub-based subscribers may be willing to accept higher levels of call blocking than conventional wireless handset users, resulting in higher levels of percentage channel utilization.

Thus, in accordance with the various aspects of the invention, outgoing calls are handled as follows: (a) the handset makes a request to the cordless access radio protocol stack 330, 430 for an external call to be made; the cordless base uses its normal mechanism to make that call, creating control plane signaling appropriate to its network side interface (special signals on the voice pair in analog systems, ISUP signaling for ISDN systems, SIP signaling for IP-based cordless bases); and (b) the cellular backhaul radio protocol stack 340, 410 interprets that request and make an outgoing call to the cellular base station using the protocols usual to that wireless interface.

For incoming calls, the propagation of the call is done in the opposite direction: (a) the call initiation at the community hub comes from the cellular network 195 and is received by the cellular backhaul radio protocol stack 340, 410; (b) this in turn initiates a call to the cordless access radio protocol stack 330, 430 using the mechanisms expected by that stack, whether they be analog, ISDN, or IP and (c) the cordless radio access protocol stack then initiates a call to the correct cordless handset over the interface 190. The key feature here is the means used to identify the correct handset to connect that incoming call to. To that end, three possible methods are proposed here, depending on the network-side interface expected by the cordless access radio protocol stack: (i) For an analog line, the cordless protocol stack determines the correct cordless handset by audibly requesting an identifier from the end-user initiating the call; or (ii) For an ISDN interface, modified ISUP signaling from the MSC 150 passes information identifying the correct cordless handset to the community hub—this information is extracted by the cellular backhaul radio protocol stack 340 and is signaled to the cordless access radio protocol stack 330 using standard, known ISUP signaling; or (iii) For an IP interface, standard, known SIP signaling from the media gateway 230 passes information (in one embodiment, a URI—uniform resource identifier) identifying the correct cordless handset to the community hub—this information is extracted by the cellular backhaul radio protocol stack 410 and is signaled to the cordless access radio protocol stack 430 using standard, known SIP signaling.

The particular communications systems and community hub configurations described above should be viewed as illustrative examples of a communications system and network apparatus (i.e., the community hub) arrangement in accordance with the principles of the invention, and it is to be understood that the invention can be implemented using other types and configurations of system components, communications standards and/or protocols.

By way of illustration but not limitation, further embodiments of the invention include configurations such that (i) voice calls are carried through the wireless network and through the hub in the form of VoIP with SIP signaling (as detailed above), however, in this embodiment the access portion of the hub is configured as an 802.11 access point (802.11 refers to the well-known family of specifications developed by the IEEE for wireless LAN technology. The 802.11 protocol specifies an over-the-air interface between a wireless client and a base station or between two wireless clients). In such an embodiment, the handsets to which the community hub transmits and communicates are 802.11 WLAN IP telephones (as available, for example, the Cisco® Wireless IP Phone 7920, as available from Cisco Systems, Inc.); or (ii) voice calls are carried through the wireless network and to the community hub using well-known voice standards (see, for example, the discussion above regarding FIGS. 1 and 2). In the hub, the signal is converted to a standard analog voice for operation on by the access mode of the community hub. Thereafter, the hub routes and transmits the call to a particular subscriber's handset (e.g., digital cordless or analog cordless) as a function of well-known touch tone based signaling exchanged between that subscriber's handset and the community hub. Further, in addition to facilitating the exchange of calls between subscribers and other individuals, the community hub also provided for the exchange of calls of amongst subscribers associated with a particular hub(s), e.g., the subscribers associated with handsets 105-1 through 105-N as shown in FIG. 1.

Thus, as each of the above-described embodiments of the invention illustrate, the community hub, by and through the cellular and access operational modes thereof, can be configured in multiple ways to achieve the advantages of the present invention for delivering communications access to a large number of users employing relatively inexpensive, widely available handsets. As detailed above, the operational features of the community hub's cellular mode include: voice and modified SS7 cellular transport and signaling over dedicated voice channels, or VoIP and SIP cellular transport and signaling over dedicated, or shared, data channels. The operational features of the community hub's access mode include: analog or digital cordless access, ISDN cordless access, SIP/IP access and 802.11 WLAN access. The community hub's switch fabric manages the cooperation between the aforementioned cellular and access modes which include: SIP/IP, SS7/ISDN and analog/touch tone signals. Such access and cellular versatility, in accordance with the various aspects of the invention, allows the community hub to interface with a myriad of lower cost, widely available handsets, such handsets including analog cordless, digital cordless, WLAN/IP phone and a PHS handset.

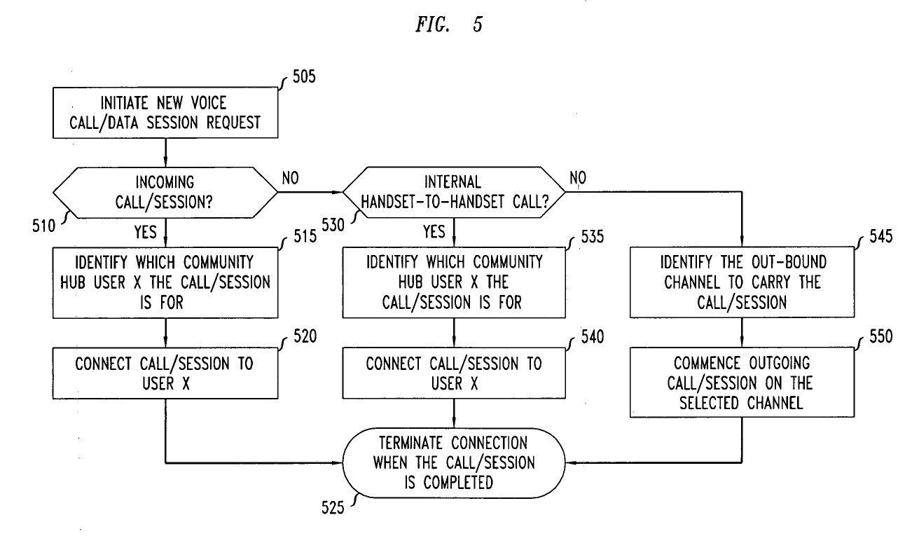

FIG. 5 shows a flowchart of illustrative operations performed by the community hub, configured in accordance with the principles of the invention, for establishing and routing a variety of communications. In step 505, a new voice call or data session (hereinafter, for convenience, referred to as “call/session”) is requested by the user (e.g., the subscriber associated with handset 105-3 in FIG. 1) or a party (e.g., the individual associated with wireless terminal 140 in FIG. 1) attempting to reach the user, for example. A determination is made as to the type of session initiated, as indicated in steps 510 and 530, respectively. If the determination, in step 510, is that the particular session is incoming to a user served by the community hub, the identity of the particular user X to which the call is destined is made, as indicated in step 515. After identifying the particular user, the connection of the call/session is made, as indicated in step 520, to such user and terminated when completed, as again indicated in step 525.

If on the other hand, the determination is made that the call was not an incoming call, a further determination is made as to whether such call in an internal handset-to-handset call, as indicated in step 530. If so, the identity of the particular user X to which the internal call is destined is made, as indicated in step 535. After identifying the particular user, the connection of the call/session is made, as indicated in step 540, to such user and terminated when completed, as indicated in step 525.

Otherwise, if not an incoming or internal call, the community hub determines that such calusession is outgoing and identify the outbound channel, across the wireless network, to carry the call/session, as indicated in step 545. Once the particular channel is selected, the outgoing calusession is commenced on the selected channel out and through the wireless network, as indicated in step 550, and again terminated when completed.

The community hub of the present invention may also provide additional functionality such as billing, outgoing call queuing (via additional well-known software functions in access part 175), incoming call routing and messaging (via well-known functionality provided by access part 175 and cellular part 180), and the ability to interconnect with other community hubs (via a hub or switch) thereby increasing overall network capacity. Further, as mentioned above, the principles of the invention include embodiments whereby multiple community hubs are interfaced together and when one hub is blocked, other additional calls may be routed utilizing one of the other interconnected hubs. For example, community hub 160 includes optional interconnections 350 (and, similarly, community hub 210 includes interconnections 440) to facilitate such interfacing community hub 160 with other community hubs.

As mentioned above, the present Applicants have also realized that the use of a protocol conversion feature, integral with the community hub of the present invention, will enable the exploitation of low-cost, off-the-shelf, high-volume cordless telephony solutions for voice communications with end users.

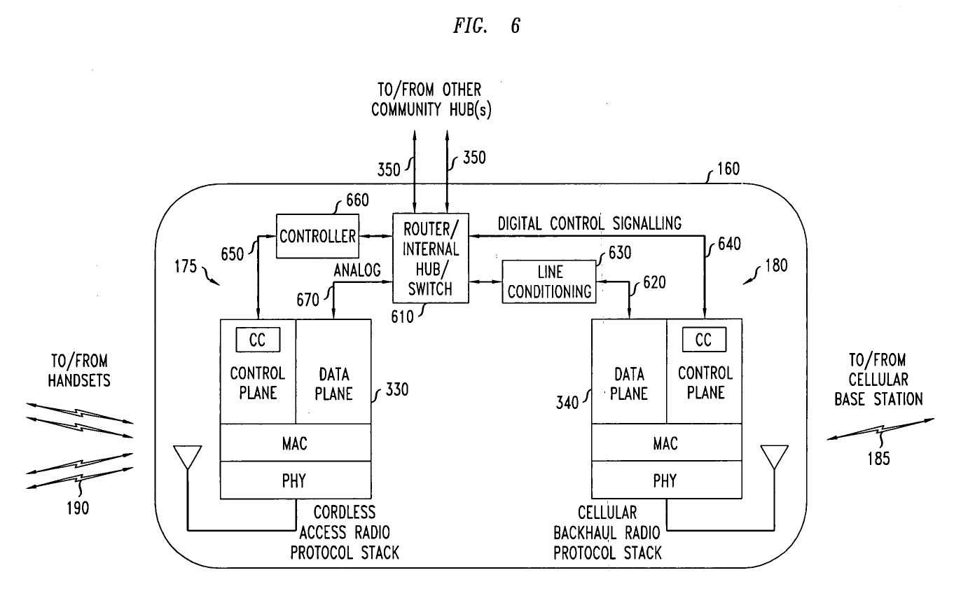

More particularly, FIG. 6 shows a functional block diagram of a further embodiment of the community hub, as illustratively depicted in FIG. 1, configured in accordance with the principles of the invention. The discussion of these further aspects of the invention is best understood with reference to FIGS. 1 and 3 and like elements (as discussed below) in FIG. 6 carry the same designation as set forth in FIGS. 1 and 3, respectively. As described above, and as illustrated in the embodiment of the invention illustratively depicted in FIG. 3 and FIG. 6, community hub 160 includes two modes of operation, namely, access mode 175 and cellular mode 180. In accordance with the embodiment of the invention illustratively depicted in FIG. 6, voice calls are exchanged between community hub 160 and the wireless communications network (e.g., wireless communications network 195 as shown in FIG. 1) using well-known and well understood voice transport configurations and methods (e.g., CDMA2000-1X). Thus, the details of cellular radio protocol stack 340 utilized in community hub's cellular mode 180 need not be explained in detail other than to highlight that stack 340 includes a physical (PHY) layer for detecting and decoding transmissions over interface 185, a MAC layer to handle all medium access control functions associated with interface 185, a data plane for further higher-layer functions for the data (in the current embodiment, voice packets), and a control plane for processing higher-layer control signaling. In access mode 175, community hub 160 utilizes cordless access radio protocol stack 330 to manage the communications to and from the subscriber handsets (i.e., handsets 105-1 through 105-N as shown in FIG. 1) across, illustratively, interface 190. As will be well understood, cordless access radio protocol stack 330 includes a physical (PHY) layer for detecting and decoding transmissions over interface 190, a MAC layer to handle all medium access control functions associated with interface 190, a data plane for further higher-layer functions for the data (in the current embodiment, voice), and a control plane for processing higher-layer control signaling.

In accordance with this embodiment of the invention, calls are exchanged by community hub 160 with the wireless network over dedicated voice channels. That is, in accordance with the principles of the invention, community hub 160 is able to facilitate a higher utilization of voice channels via the wireless network in that the community hub is able to manage multiple subscribers over one uplink (e.g., one voice channel). This arises because community-hub-based subscribers may be willing to accept higher levels of call blocking than conventional wireless handset users, resulting in higher levels of percentage channel utilization.

In accordance with the embodiment of FIG. 6, switch 610 employs a switched fabric such that, within community hub 160 the transport 620 used to carry communications traffic to/from access portion 175 is well-known analog voice (see, e.g., analog voice signal path 670). In certain situations, for example, where the impedances or number of lines expected by the analog interface into the access portion 175 differ from that supplied by the cellular portion 180, therefore, community hub 160 may include certain line-conditioning circuitry 630.

In order to identify a particular handset (e.g., handset 105-1 as shown in FIG. 1), a method for signaling that identity involves exchanging information across the digital control interfaces 640 and 650, respectively, with a controller 660. There are multiple methods for obtaining information regarding the identity of the called party (during calls originating from the PSTN 155) from the cellular portion 180. One of ordinary skill in the art will appreciate that this information might be obtained through the following known sequence of steps:
(a) An incoming call coming from the PSTN 155 results in an IAM (incoming address message) being sent to the MSC 150. This message may contain a DN (directory number) identifying the correct community hub user, for example, the user associated with handset 105-1;
(b) The MSC may send the DN on to the base station 135 as part of the “MS Information” record in an “Assignment Request” message, sent as part of the call set-up procedure;
(c) If received by base station 135, the base station must then send the DN on to the cellular portion 180 of the community hub 160 using the “Alert with Information” message; and
(d) Modifications to the call control in the cellular protocol stack 340 can result in DN being passed to the controller 660.
   The disadvantage of this methodology is that it requires changes to at least the call control stack and the API (application programmer interface) typically presented by that stack to outside applications (e.g. over interface 640), further, these APIs generally do not present information regarding the called party, including the DN. Another disadvantage of this method is that it may require changes to existing MSC implementations, to pass the information on the called DN to the community hub 160.

In recognition of the above disadvantage, the present Applicants have realized certain novel methods, in context of the community hub principles of the invention, for providing the called party directory number (“DN”) to the controller 660 without modifying the protocol stack 340 of the cellular portion 180 or requiring the MSC to support the inclusion of the called party DN as part of the “MS Information” record in an “Assignment Request” message. Essentially, the present Applicants have realized that by modifying certain expected information from the cellular protocol stack the community hub will be able to perform certain protocol conversions between analog voice signaling and the expected signaling protocols associated with the access side of the community hub, thereby providing the community hub with the flexibility of interfacing with any number of low-cost, off-the-shelf, high-volume cordless telephones for the delivery of wireless communications services to a subscriber base in developing regions.

In accordance with such embodiments of the invention, an operation is employed (illustratively, in a controller, as detailed further hereinbelow) for receiving a message having a plurality of fields, where the message has a form compliant with a second communications protocol (i.e., the wireless communications protocol such as CDMA), and a control signal is extracted as a function of a particular one field of the plurality of fields. Such one field contains information conforming with a first communications protocol (i.e., the cordless telephony protocol such as a digital cordless telephone standard) but not with a second communications protocol, such that the control signal is used for identifying the particular one subscriber associated with the one handset which is in communication with the community hub. Said another way, in accordance with such embodiments of the invention, as detailed further below, information useful by the “access” side of the community hub is embedded in the message generated from the “cellular” side of the community hub. Thus, the message transmitted by the wireless communications network (as received by the community hub) is in a form compliant with the relevant wireless communications protocol but a particular field of such message contains information which conforms with (i.e., will be recognized by and useful with) the other (i.e., different than the second communications protocol associated with the wireless network) communications protocol being utilized on the “access” side of the hub (i.e., utilized for identifying and communicating with the handsets of the users communicating with the hub).

More particularly, the following is one such embodiment of the invention:
(a) The MSC 150 receives the IAM with the called party DN from the PSTN 155;
(b) As part of normal operations, the MSC will pass the DN to the HLR 151;
(c) The HLR has enough information to be able to identify the requested DN as being associated with a community hub user. It will return a MIN (mobile identification number) identifying the cellular portion 180 of the community hub 160 with which the cordless user is associated, for example, the user associated with handset 105-1;
(d) The HLR can also return a so-called “Alert Code” which has one of 39 allowed values to identify the correct ring tone to be used at the mobile. In accordance with the invention, this field is employed for a different use (i.e., different from the stand implementation of such well-known Alert Codes), namely to identify one of up to 39 cordless handsets (for example, cordless handsets 105-1 through 105-N as shown in FIG. 1) interfaced with community hub 160. In accordance with the invention, this modified Alert Code is sent to the MSC (for example, MSC 150);
(e) The MSC then initiates the usual call set-up procedures. As part of those procedures, the modified Alert Code will be sent to the cellular portion 180 of the community hub 160; and
(f) The API for many existing solutions for the cellular portion are capable of passing the Alert Code to applications that may access the cellular protocol stack 340. Thus, controller 660 can access the modified Alert Code over the interface 640 and from this deduce the correct cordless handset (for example, handset 105-1) to direct the call to.
   Advantageously, no changes to the cellular portion protocol stack 340 are needed to support this embodiment of the invention. In the network infrastructure, all that is required is that the Alert Code is provisioned properly in HLR 151 (i.e., the data in the HLR is consistent with that in the community hub).

Another embodiment of the invention directed at the community hub performing directly the necessary protocol conversions for facilitating communications between its access and wireless operational modes, as detailed above, involves the following:
(a) The MSC 150 receives the IAM with the called party DN from the PSTN 155;
(b) As part of normal operations, the MSC will pass the DN to the HLR 151;
(c) The HLR has enough information to be able to identify that the requested DN is associated with a particular community hub cordless handset (for example, handset 105-1. It will return a MIN (mobile identification number) identifying the cellular portion 180 of the community hub 160 with which the cordless user is associated, for example, the user associated with handset 105-1;
(d) The HLR, as part of the normal call set-up procedures, can signal the Calling Name of the caller from the PSTN in the “Display Text” field. In accordance with this embodiment of the invention, the Display Text field is used to signal the DN of called party; in other words, the Calling Name is modified to be the called party DN. The Display Text field contents are sent by the HLR to the MSC.

(e) The MSC then initiates the usual call set-up procedures. As part of the those procedures, the modified Calling Name will be sent to the cellular portion 180 of the community hub 160; and

(f) The API for existing solutions for the cellular portion can pass the Display Text to applications that may access the cellular backhaul protocol stack 340. Thus, the controller 660 can access the modified Caller ID field over the interface 640 and this field gives the DN of the cordless handset (for example, handset 105-1 the controller should direct the call to.

No changes to the cellular portion protocol stack 340 are needed to support this embodiment of the invention. Modifications to the network infrastructure are confined to the HLR 151. More particularly, such changes are (i) the HLR identifies that the called party is a community hub cordless handset and (ii) the HLR sets the Display Text field according to the DN of the called party, not the Calling Name.

A further embodiment of the invention directed at the community hub performing directly the necessary protocol conversions for facilitating communications between its access and wireless operational modes, as detailed above, involves the following:
(a) The MSC 150 receives the IAM with the called party DN from the PSTN 155;
(b) As part of normal operations, the MSC will pass the DN to the HLR 151;
(c) The HLR has enough information to be able to identify that the requested DN is associated with a particular community hub cordless handset (for example, handset 105-1. The fact that this is a community hub cordless handset is flagged as being true to the MSC through non-standard signaling between HLR 151 and MSC 150;
(d) The MSC, as part of the normal call set-up procedures, will signal the ID of the caller from the PSTN (i.e., the well-known “Caller ID” signal/field).

In accordance with this embodiment of the invention, the Caller-ID field is used to signal the DN of called party; in other words, the Caller ID is modified to be the called party DN. Thus, the modified Caller ID will be sent to the cellular portion 180 of the community hub 160; and

(e) The API for many existing solutions for the cellular portion can pass the Caller ID to applications that may access the cellular backhaul protocol stack 340. Thus, the controller 660 can access the modified Caller ID field over the interface 640 and this field gives the DN of the cordless handset (for example, handset 105-1 the controller should direct the call to.

No changes to the cellular portion protocol stack 340 are needed to support this embodiment of the invention. Modifications to the network infrastructure are confined to the HLR 151 and the MSC 150. More particularly, such changes are (i) the HLR identifies that the called party is a community hub cordless handset and flags this for the MSC, and (ii) the MSC sets the Caller ID field according to the DN of the called party, not the DN of the caller. Also, the term “caller identification code” as used herein is meant to include the aforementioned “Caller ID” and/or “Caller Name”.

Another embodiment of the invention directed at the community hub performing directly the necessary protocol conversions for facilitating communications between its access and wireless operational modes, as detailed above, involves:
(a) The MSC 150 receives the IAM with the called party DN from the PSTN 155;
(b) As part of normal operations, the MSC will pass the DN to the HLR 151;
(c) The HLR has enough information to be able to identify that the requested DN is associated with a community hub cordless handset (for example, handset 105-1);
(d) In accordance with this embodiment of the invention, the HLR sends a short text message using, for example, the Short Messaging Service (SMS), to the cellular portion 175 of the associated community hub 160.

This text message contains the DN of the called party and the DN of the calling party, i.e. the caller-ID. In other words, in accordance with this aspect of the invention, the SMS service is employed in a different way from conventional uses for the delivery of the DN of the called party;
(e) The controller 660 receives this text message through the normal facilities available from the API for the cellular portion. The controller then extracts the called party DN and the calling party DN; and
(f) Soon after the HLR sends the SMS, the MSC initiates normal call set-up procedures. The controller 660 detects the calling party DN and checks that this corresponds to the calling party DN in the recently received SMS. If the two correspond then the controller directs the call to the correct cordless handset (for example, handset 105-1) based on the DN received in the previous text message.
   No changes to the cellular portion protocol stack 340 are needed to support this. Modifications to the network infrastructure are confined to the HLR 151. More particularly, the changes are: (i) the HLR identifies that the called party is a community hub cordless handset; and (ii) the HLR sends to the community hub an SMS containing the DN of the called party and the DN of the calling party.

The foregoing merely illustrates the principles of the invention. It will thus be appreciated that those skilled in the art will be able to devise various arrangements which, although not explicitly described or shown herein, embody the principles of the invention and are within its spirit and scope. For example, one skilled in the art, in light of the descriptions of the various embodiments herein, will recognize that the principles of the present invention may be utilized in widely disparate fields and applications. All examples and conditional language recited herein are intended expressly to be only for pedagogical purposes to aid the reader in understanding the principles of the invention and are to be construed as being without limitation to such specifically recited examples and conditions. Moreover, all statements herein reciting aspects and embodiments of the invention, as well as specific examples thereof, are intended to encompass functional equivalents thereof.

Further, the invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The invention can also be embodied in the form of program code, for example, in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

We claim:

1. A network apparatus having a first and second operating mode, said first operating mode primarily supporting a first interconnection with a plurality of handsets, said second operating mode primarily supporting a second interconnection with a wireless communications network, said network apparatus comprising:
a first antenna for interfacing, in said first operating mode, said plurality of handsets with said network apparatus, said first operating mode being specific to a voice telephony protocol, and each said handset being associated with a particular one subscriber of a plurality of subscribers;
a second antenna for interfacing said network apparatus with said wireless communications network in said second operating mode, said second operating mode being specific to a VoIP communications protocol;
a switch for processing and exchanging, between said first operating mode and said second operating mode, a communication signal associated with a particular one handset of said plurality of handsets, wherein said switch converts said communication signal between said voice telephony protocol and said wireless communications protocol as said communication signal is processed and exchanged between said first operating mode and said second operating mode; and
wherein said network apparatus cooperatively employs said first operating mode and said second operating mode in transmitting a communication between said handset and said wireless communications network.

2. The network apparatus of claim 1, wherein said communication is a call originated by said particular one subscriber to a wireless terminal accessible by said wireless communications network.

3. The network apparatus of claim 1, wherein said communication is a call originated from a wireless terminal accessible by said wireless communications network to said handset associated with said particular one subscriber.

4. The network apparatus of claim 2, wherein said call is originated using a cordless telephone signal and said network apparatus converts said cordless telephone signal to a cellular signal for said transmitting said communication between said handset and said wireless communications system.

5. A network apparatus having a first and second operating mode, said first operating mode primarily supporting a first interconnection with a plurality of handsets, said second operating mode primarily supporting a second interconnection with a wireless communications network, said network apparatus comprising:
a first antenna for interfacing, in said first operating mode, said plurality of handsets with said network apparatus, said first operating mode being specific to a first communications protocol, and each one of said handsets being associated with a particular one subscriber of a plurality of subscribers;
a second antenna for interfacing said network apparatus with said wireless communications network in said second operating mode, said second operating mode being specific to a second communications protocol;
a switch for processing and exchanging, between said first operating mode and said second operating mode, a communication signal associated with a particular one handset of said plurality of handsets, wherein said switch converts said communication signal between said first communications protocol and said second communications protocol as said communication signal is processed and exchanged between said first operating mode and said second operating mode;
a controller for receiving a message having a plurality of fields, said message having a form compliant with said second communications protocol, and extracting a control signal as a function of a particular one field of said plurality of fields, said particular one field containing information conforming with said first communications protocol but not with said second communications protocol, such that said controller uses said control signal for identifying said particular one subscriber associated with said one handset; and
wherein said network apparatus cooperatively employs said first operating mode and said second operating mode in transmitting said communication signal between said particular one subscriber associated with said one handset and said wireless communications network.

6. The network apparatus of claim 5, wherein said control signal includes an alert code generated by said wireless communications network, said alert code identifying said particular one handset.

7. A network apparatus of claim 5, wherein said control signal includes a caller identification code generated by said wireless communications network, said caller identification code being associated with said one subscriber associated with said one handset, wherein said one subscriber is a called party in receiving said communications signal.

8. The network apparatus of claim 5, wherein said control signal includes a Short Messaging Service (SMS) textual message, said SMS textual message identifying said one subscriber associated with said one handset.

9. The network apparatus of claim 8, wherein said first communications protocol is a digital cordless signal protocol and said second communications protocol is a CDMA communications protocol.

10. The network apparatus of claim 7, wherein said caller identification code is specific to an ISUP protocol.

11. A communications system comprising:
a plurality of handsets, each said handset being associated with a particular one subscriber of a plurality of subscribers;
a network apparatus operative for communicating, in a first operating mode, between said network apparatus and said plurality of handsets, and for communicating, in a second operating mode, between said network apparatus and a wireless communications network, said network apparatus further comprising:
a switch for converting a communication signal between a first communications protocol and a second communications protocol as said communication signal is processed and exchanged between said first operating mode and said second operating mode; and
a controller for receiving a message having a plurality of fields, said message being generated by said wireless communications network and having a form compliant with said second communications protocol, and extracting a control signal as a function of a particular one field of said plurality of fields, said particular one field containing information conforming with said first communications protocol but not with said second communications protocol, such that said controller uses said control signal for identifying said particular one subscriber associated with said one handset; and
wherein said network apparatus cooperatively employs said first operating mode and said second operating mode in processing and exchanging a call associated with a particular one handset of said plurality of handsets.

12. The communications system of claim 11, wherein said call is originated by a wireless terminal associated with said wireless communications network to said particular one subscriber associated with said handset, said handset being a cordless telephone and said network apparatus converts a cellular signal received by said network apparatus from said wireless network to a cordless telephone signal for transmission to said cordless telephone from said network apparatus.

13. The communications system of claim 11, wherein said control signal includes an alert code generated by said wireless communications network, said alert code identifying said particular one handset.

14. The communications system of claim 11, wherein said control signal includes a caller identification code generated by said wireless communications network, said caller identification code being associated with said one subscriber associated with said one handset, wherein said one subscriber is a called party in receiving said communications signal.

15. A community hub apparatus comprising:
a switch for processing and exchanging, between a first operating mode and a second operating mode, a communication signal associated with a particular one handset of said plurality of handsets, wherein said switch converts said communication signal between a first communications protocol associated with said first operating mode and a second communications protocol associated with said second operating made as said communication signal is processed and exchanged between said first operating mode and said second operating mode;
a controller for receiving a message having a plurality of fields, said message having a form compliant with said second communications protocol, and extracting a control signal as a function of a particular one field of said plurality of fields, said particular one field containing information conforming with said first communications protocol but not with said second communications protocol, such that said controller uses said control signal for identifying said particular one subscriber associated with said one handset.

16. The community hub apparatus of claim 15, wherein said message is generated by a wireless communications network and said control signal includes an alert code generated by a wireless communications network, said alert code identifying said particular one handset.

17. The community hub apparatus of claim 15, wherein said first communications protocol is specific to a cordless voice telephony protocol and said control signal includes a caller identification code generated by a wireless communications network, said caller identification code being associated with a particular one subscriber associated with said one handset, wherein said one subscriber is a called party.

18. A method of operating a network apparatus for providing communications services between a wireless communications network and a plurality of users, each said user being associated with a particular one handset, said method comprising:
receiving a communications signal; and
processing and exchanging, between a first operating mode and a second operating mode, said communications signal associated with said particular one handset of said plurality of handsets, said first mode being operative for interfacing said network apparatus with said plurality of handsets, and said second operating mode being operative for interfacing said network apparatus with said wireless communications network, wherein said processing and exchanging further comprises the steps of:
converting said communications signal between a first communications protocol associated with said first operating mode and a second communications protocol associated with said second operating mode as said communication signal is processed and exchanged between said first operating mode and said second operating mode; and
identifying said particular one subscriber associated with said one handset as a function of a control signal, said control signal being extracted as a function of a particular one field of a plurality of fields of a message generated from said wireless communications network, said particular one field containing information conforming with said first communications protocol but not with said second communications protocol; and
cooperatively employing said first operating mode and said second operating mode in communicating said communications signal between said particular one handset associated with said user and said wireless communications network.

19. The method of claim 18, wherein said control signal includes an alert code generated by said wireless communications network, said alert code identifying said particular one handset.

20. The method of claim 18, wherein said control signal includes a caller identification code generated by said wireless communications network, said caller identification code being associated with said one subscriber associated with said one handset, wherein said one subscriber is a called party in receiving said communications signal.
